(19) United States
(12) Patent Application Publication
(10) Pub. No.: US 2022/0016759 A1
(43) Pub. Date: Jan. 20, 2022

(54) Robotic Arm

(71) Applicants: Fieldwork Robotics Limited, Plymouth, Devon (GB); UNIVERSITY OF PLYMOUTH, Devon (GB)

(72) Inventors: Thomas Sauerwald, Cambridge (GB); Ignacio Martin Requena, Cambridge (GB); Maximilian Knolseisen, Cambridge (GB); Khaian Marsh, Cambridge (GB); Alfred Wilmot, Plymouth, Devon (GB); Martin Stoelen, Plymouth, Devon (GB); Sandra Busch, Plymouth, Devon (GB)

(21) Appl. No.: 17/311,274

(22) PCT Filed: Dec. 4, 2019
(86) PCT No.: PCT/GB2019/053423

§ 371 Date: Jun. 4, 2021

(30) Foreign Application Priority Data
Dec. 5, 2018 (GB) 1819824.2
Dec. 5, 2018 (GB) 1819825.9
Dec. 5, 2018 (GB) 1819826.7

(51) Int. Cl. B25J 9/08; B25J 15/04; B25J 9/10; B25J 17/02; B25J 11/00; B25J 5/00; B25J 9/00; A01D 46/30

(52) U.S. Cl. CPC B25J 9/08; B25J 15/04; B25J 15/0408; B25J 9/104; A01D 46/30; B25J 11/0045; B25J 5/007; B25J 9/0084; B25J 17/0233

(57) ABSTRACT

In general terms a first aspect of the invention provides a modular robotic arm in which respective joint modules and/or end effector modules can be swapped or exchanged for a replacement module. The modules are interconnected by pairs of interlocking features that can be readily and repeatably interlocked and separated.

### TECHNICAL FIELD

The present application concerns embodiments relating to features of and for a passively compliant robotic arm, and related methods.

### BACKGROUND

Passively compliant robotic arms have a relatively low resistance to deflection resulting from an externally applied load. As such, they are particularly suitable for operation in environments shared with humans, where accidental contact between humans and robotic arms may occur.

Stoelen, M. et al have explored some developments in “Co-exploring actuator antagonism and bio-inspired control in a printable robot arm”, International Conference on Simulation of Adaptive Behavior, SAB 2016: From Animals to Animats 14 pp 244-255, 2016. The focus of the present application is improvements to the hardware and operation of passively compliant robotic arms to allow for flexibility and ruggedness in use.

### SUMMARY OF THE INVENTION

In general terms a first aspect of the invention provides a modular robotic arm in which respective joint modules and/or end effector modules can be swapped or exchanged for a replacement module. The modules are interconnected by pairs of interlocking features that can be readily and repeatably interlocked and separated.

Thus, a first aspect of the invention provides a modular robotic arm comprising: a first joint module comprising: a first joint that is movable to cause movement between rigid first and second links, the first or second link comprising a first interlocking feature; and a first variable stiffness actuator having one or more resilient members actuatable to move the first joint; and a second module comprising a second interlocking feature configured to interlock with the first interlocking feature of the first module, wherein the robotic arm has an operating mode in which the second interlocking feature is interlocked with the first interlocking feature to thereby operatively connect the second module to the first module, and a reconfiguration mode in which the second interlocking feature is separated from the first interlocking feature to thereby enable the first or second module to be swapped for a replacement module, and wherein in the operating configuration the one or more resilient members do not engage the second module.

This modular arrangement enables modules of the robotic arm to be straightforwardly and repeatably removed and replaced, for example for planned maintenance or in-service repair, in order to reduce downtime of the arm. Moreover, one or more modules may be replaced with a module that has different operating characteristics. For example, an end effector module may be selected from a range of end effector modules having different end effector types with different capabilities. Similarly, a joint module may be replaced with an equivalent joint module having different performance characteristics, for example different speed vs torque output characteristics.

Moreover, this modular arrangement can be achieved without any modification to any features of the first joint module, since the variable stiffness actuator is contained within a single module, the one or more resilient members not engaging the second module in any way. That is, the one or more resilient members do not cross the join between the first and second interlocking features. Put another way, the one or more resilient members do not extend across the interlocked first and second interlocking features in the operating mode.

When the first and second interlocking features are interlocked in the operating mode the interlocking preferably provides a rigid connection between the first and second module such that no relative movement between the first and second module is permitted at the join between the first and second interlocking features.

In preferred embodiments the second module comprises either: an end effector module comprising an end effector arranged to manipulate an object; or a second joint module comprising a second joint that is movable to cause movement between rigid third and fourth links, the third or fourth link comprising the second interlocking feature, and a second variable stiffness actuator having one or more resilient members actuatable to move the second joint.

In some embodiments the first link comprises the first interlocking feature, the second link comprises a third interlocking feature, and the robotic arm comprises a third module having a fourth interlocking feature arranged to interlock with the third interlocking feature of the first module in the operating mode, the third and fourth interlocking features being separated in the reconfiguration mode to enable the first or third module to be swapped for a replacement module.

Preferably, one of the first and second interlocking features comprises a female element and the other of the first and second interlocking features comprises a male element arranged to nest within the female element to thereby interlock the first and second interlocking features together. This provides a mechanically simple interlocking arrangement. Moreover, such an arrangement provides a repeatably accurate location of each module relative to its neighbour.

The first and second interlocking features may be interlocked via a sliding connection. Such an arrangement is particularly straightforward to use, and also to manufacture.

The first and second interlocking features are preferably interlocked via a frictional engagement. This enables a close fit between the interlocking features, and thus an accurate location of modules relative to one another.

The first and second interlocking features may be interlocked via a one-step connection. That is, the connection is preferably such that the first and second interlocking features can be interconnected by a single movement that interlocks the features and connects the first and second modules together. A subsequent step may be included to secure the connection or provide a fail-safe back-up connection if necessary.

The first and second interlocking features are preferably interlocked without additional fastening means. That is, there are preferably no additional fasteners needed to interlock the first and second interlocking features. Such fasteners may be included as a fail-safe or back-up connection, but are not needed to provide the rigid interlocking engagement.

In particularly preferred embodiments the first and second interlocking features comprise cooperating sliding dovetail joint features.

The third and fourth interlocking features may comprise any of the features of the first and second interlocking features as defined herein.

The first and/or second variable stiffness actuator may comprise a first resilient member of the one or more resilient members actuatable by an increase in tension to urge the joint to move in a first direction, and a second resilient member of the one or more resilient members actuatable by an increase in tension to urge the joint to move in a second direction opposite to the first direction

The first and/or second variable stiffness actuator may comprise first and second bi-directional actuators, each bi-directional actuator comprising a first resilient member of the one or more resilient members actuatable by an increase in tension to urge the joint to move in a first direction, and a second resilient member of the one or more resilient members actuatable by an increase in tension to urge the joint to move in a second direction opposite to the first direction.

The first and/or second variable stiffness actuator may be operable in a low stiffness mode in which a resultant tension in the one or more resilient members is relatively low and a high stiffness mode in which the resultant tension in the one or more resilient members is relatively high.

The one or more resilient members are preferably each connected to the first link and the second link. The connection may be a direct connection, or may be an indirect connection. For example, the one or more resilient members may comprise portions of an actuation link that is driven by a pulley wheel mounted on the first or second link, the actuation link being otherwise connected to the other of the first or second link.

The first and/or second variable stiffness actuator may comprise one or more actuators, each actuator comprising a first pulley rotatable relative to the first link and rotatable in tandem with the second link, a second pulley rotatable relative to the first link, and an actuation link extending between the first and second pulleys, the actuation link including at least one of the one or more resilient members extending between the first and second pulleys whereby rotation of the first or second pulley causes movement of the joint.

The present invention also provides a kit of parts comprising a robotic arm according to the first aspect, and a replacement second module comprising a further second interlocking feature arranged to interlock with the first interlocking feature of the first module, wherein either the second module or replacement second module can be operatively connected to the first module in the operating configuration.

The present invention further provides a method of operating a robotic arm according to the first aspect, comprising the steps of: disconnecting the first and second interlocking features; replacing the first or second module with a replacement module comprising a further interlocking feature; and interlocking the first or second interlocking feature with the further interlocking feature to arrange the robotic arm in the operating mode.

The method may further comprise the step of operating the robotic arm in the operating mode to harvest fruit or vegetables. Similarly, the present invention provides a system for harvesting fruit or vegetables comprising a movable base supporting one or more robotic arms according to the first aspect.

In general terms a second aspect of the present invention provides a means by which the torque vs speed output of a joint in a robotic arm may be controlled. That is, a variable stiffness actuator that actuates the joint can be modified to deliver the desired torque vs speed characteristics. This modification is achieved by varying an actuation distance about which an actuation link is pivoted.

Thus, a second aspect of the invention provides a robotic arm comprising: a joint that is movable to cause relative movement between first and second links; and a variable stiffness actuator including an actuation link comprising one or more resilient members and an actuation member engaging the actuation link, the actuation member being movable to move the actuation link about an axis along an arc defined by an actuation distance from the axis to thereby alter a tension in the one or more resilient members to cause movement of the joint, wherein the actuation distance is variable to vary one or more parameters of the joint movement.

This arrangement enables the capabilities of the joint to be tuned to the specific application for which the arm is being used. For example, where a relatively high torque output is required the actuation distance may be relatively high, and where a relatively high joint speed of movement is required the actuation distance may be relatively low.

In some embodiments the actuation member comprises a pulley rotatable about the axis, the pulley having a track for engaging the actuation link along the arc defined by the actuation distance, the track being movable relative to the axis to vary the actuation distance. For example, the track may comprise a plurality of discrete portions arranged in a ring and able to move radially with respect to one another to thereby vary the actuation distance.

Similarly, the actuation member may comprise first and second pulleys rotatable about the axis, each of the first and second pulleys having a track for engaging the actuation link along the arc defined by the actuation distance, the track of the first pulley having a first actuation distance and the track of the second pulley having a second actuation distance different to the first actuation distance, and wherein the actuation distance is variable by engaging the actuation link with either the first pulley or the second pulley.

In some embodiments the first and second pulleys are integral such that the tracks are rotatable about the axis simultaneously. Thus, the actuation link may be swapped from one pulley to the other without any additional steps being necessary.

Alternatively the first and second pulleys may be independent such that the tracks are rotatable about the axis independently. In this way, only one of the first and second pulleys may be rotatable about the axis (i.e. installed in the variable stiffness actuator) at any one time. The end user may swap the first and second pulleys over, depending on the operating characteristics of the joint that are required for a particular application.

Preferred embodiments comprise a tension control mechanism having a low tension configuration in which a tension in the one or more resilient members is relatively low and a high tension configuration in which a tension in the one or more resilient members is relatively high. For example, the relatively low tension in the low tension configuration may be sufficiently low to enable the actuation distance to be varied, e.g. by altering or replacing the actuation member (pulley), and/or the relatively high tension in the high tension configuration may be sufficiently high to provide an operating tension in which the actuation member (pulley) is able to effectively drive the actuation link.

Such a tension control mechanism may comprise one or more clamping members that each clamp a portion of the actuation link (e.g. a free end of the actuation link), each clamping member being moveable (e.g. slideable) relative to the actuation member (pulley) to thereby change an effective length of the actuation link. The or each clamping member may comprise a slider moveable within a sliding block. An adjustment member having a screw thread cooperable with a screw thread of the clamping member (slider) may be rotatable to thereby move the clamping member.

The one or more clamping members are preferably removably mounted on a portion of the robotic arm other than the actuation member (pulley); for example, the one of more clamping members may be removably mounted on a further pulley engaging the actuation link. The further pulley may comprise a driven pulley whereby movement of the actuation link in use causes movement of the driven pulley. The one or more clamping members thus preferably have an installed configuration in which they are mounted on a portion of the robotic arm other than the actuation member (pulley), and an uninstalled configuration in which they are dismounted from the portion of the robotic arm other than the actuation member (pulley).

In the uninstalled configuration of the one or more clamping members the actuation link may be replaced with a replacement actuation link. For example, in embodiments in which the actuation member (e.g. first pulley) is swapped for a replacement actuation member (e.g. second pulley) having a different actuation distance, the actuation link associated with the actuation member (e.g. first pulley), and having a length appropriate for that actuation member, may be replaced with an actuation link associated with the replacement actuation member (e.g. second pulley) and having a length appropriate for that replacement actuation member. Thus, the actuation member and associated actuation link may be readily replaced by initially placing the one or more clamping members in the uninstalled configuration.

For example, the actuation link may comprise one or more clamping members and the replacement actuation link may comprise one or more replacement clamping members whereby the actuation member and actuation link may be replaced by placing the one or more clamping members in the uninstalled configuration, removing the actuation member and actuation link, installing the replacement actuation member and replacement actuation link, and placing the one or more replacement clamping members in the installed configuration. The one or more replacement clamping members may be further moved relative to the actuation member to thereby reduce an effective length of the replacement actuation link, and thus increase a tension in the one or more resilient members of the replacement actuation link.

In preferred embodiments the one or more clamping members (and/or one or more replacement clamping members) are each movable relative to the actuation member (pulley) to thereby change the effective length of the actuation link along a predetermined path having a predetermined length. Thus, movement of the one or more clamping members along a full extent of the predetermined path has the effect of providing a pre-determined length for the respective actuation link. This provides a reliable and repeatable arrangement for providing the correct pre-tension in each actuation link.

The variable stiffness actuator may comprise a first resilient member of the one or more resilient members actuatable by an increase in tension to urge the joint to move in a first direction, and a second resilient member of the one or more resilient members actuatable by an increase in tension to urge the joint to move in a second direction opposite to the first direction

The variable stiffness actuator may comprise first and second bi-directional actuators, each bi-directional actuator comprising a first resilient member of the one or more resilient members actuatable by an increase in tension to urge the joint to move in a first direction, and a second resilient member of the one or more resilient members actuatable by an increase in tension to urge the joint to move in a second direction opposite to the first direction.

The variable stiffness actuator may be operable in a low stiffness mode in which a resultant tension in the one or more resilient members is relatively low and a high stiffness mode in which the resultant tension in the one or more resilient members is relatively high.

The one or more resilient members are preferably each connected to the first link and the second link. The connection may be a direct connection, or may be an indirect connection. For example, the one or more resilient members may comprise portions of an actuation link that is driven by a pulley wheel mounted on the first or second link, the actuation link being otherwise connected to the other of the first or second link.

The variable stiffness actuator may comprise one or more actuators, each actuator comprising a first pulley rotatable relative to the first link and rotatable in tandem with the second link, a second pulley rotatable relative to the first link, and the actuation link extends between the first and second pulleys, the actuation link including at least one of the one or more resilient members extending between the first and second pulleys whereby rotation of the first or second pulley causes movement of the joint, wherein the actuation distance is variable by modifying the first and or second pulleys.

The invention also provides a kit of parts comprising a robotic arm according to the second aspect, wherein the variable stiffness actuator comprises a pulley that is rotatable about the axis and has a track for engaging the actuation link along the arc defined by the actuation distance, the kit further including a replacement pulley for installing in place of the pulley, the replacement pulley, when installed, being rotatable about the axis and having a track for engaging the actuation link along the arc defined by the actuation distance, wherein the track of the pulley has a first actuation distance and the track of the replacement pulley has a second actuation distance different to the first actuation distance.

Similarly, the invention provides a method of operating a robotic arm according to the second aspect, comprising the steps of: moving the joint by operating the variable stiffness actuator in a first mode in which the actuation distance comprises a first actuation distance; modifying the variable stiffness actuator to change the actuation distance to a second actuation distance different to the first actuation distance; and moving the joint by operating the variable stiffness actuator in a second mode in which the actuation distance comprises the second actuation distance.

The method may further comprise the step of operating the robotic arm in the operating mode to harvest fruit or vegetables. The invention also provides a system for harvesting fruit or vegetables comprising a movable base supporting one or more robotic arms according to the second aspect.

A third aspect of the invention provides an end effector that provides a cutting blade that is able to cut in any direction relative to the blade.

Thus, a third aspect of the invention provides an end effector for a robotic arm, the end effector comprising a rigid static portion comprising a base adapted for attachment to a robotic arm and a pair of arms extending outwardly from the base, a cutting wire extending between the pair of arms to define a cutting portion of the wire for cutting an object, and a drive system arranged to reciprocate the wire in the cutting portion along its length relative to the pair of arms.

The cutting portion is thus able to cut in any direction generally at an angle to (e.g. generally normal to) the cutting portion. Moreover, the cutting wire is tolerant of bending and therefore able to withstand forces applied to it by environmental factors, such as impacts by other machinery, people or vegetation. This arrangement is also particularly safe for people operating in the vicinity of a robotic arm carrying the end effector since the cutting wire is safe and unable to cut when it is stationary, i.e. not reciprocating. The end effector is particularly suitable for cutting the stem of a vegetable or fruit.

The drive system may comprise a motor configured to rotate first and second attachment members about their respective axes, a first free end of the cutting wire being attached to the first attachment member at a point offset from its axis, and a second free end of the cutting wire being attached to the second attachment member at a point offset from its axis, rotation of the first and second attachment members thereby causing the wire in the cutting portion to reciprocate. This arrangement provides a particularly robust mechanical arrangement for providing the reciprocating motion of the cutting wire.

The drive system is preferably located at the base, the cutting wire extending along each of the pair of arms from the cutting portion to the drive system.

The end effector may comprise a pair of pulleys, each pulley being mounted on a respective one of the pair of arms so as to be rotatable relative thereto, wherein the cutting wire passes around each of the pulleys.

In preferred embodiments the cutting portion of the cutting wire is able to cut equally at all positions around its surface. For example, the cutting wire may have one or more cutting faces extending around a periphery of the cutting portion of the cutting wire. The one or more cutting faces may comprise a plurality of serrations, teeth, or other cutting members configured to provide a cutting effect when the cutting portion is reciprocated. In particularly preferred embodiments the one or more cutting faces are configured to provide no cutting effect when the cutting portion is not reciprocated. For example, the cutting surfaces may comprise a plurality of blunt or rounded protrusions projecting radially outwardly from the cutting portion of the cutting wire.

A fourth aspect of the invention provides an end effector able to clamp, or otherwise grasp, an object, for example to enable a subsequent processing step to be applied to the object. The end effector comprises a belt arranged in a loop, the size of the loop being variable so that an object encircled by it can be held.

Thus, a fourth aspect of the invention provides an end effector for a robotic arm, the end effector comprising a rigid static portion adapted for attachment to a robotic arm, a belt forming a loop extending from the static portion, and a drive system configured to move the belt relative to the static portion to alter a size of the loop to thereby enable an object encircled by the loop to be grasped by the belt.

This arrangement provides a particularly robust and repeatable method of clamping an object using a robotic arm. It is particularly suitable for grasping larger vegetables or fruit in order to perform a subsequent processing step, such as cutting a stem, thereon.

A first portion of the belt may be fixed relative to the static portion and a second portion of the belt is movable relative to the static portion to alter the size of the loop.

The static portion may comprise one or more belt guides through which the belt passes. The belt guides help to ensure the belt maintains a consistent position with respect to the static portion of the end effector, and thus with respect to the arm to which the end effector is attached.

The drive system may comprise one or more rollers arranged to engage a second portion of the belt to thereby move the second portion relative to a first portion of the belt to alter the size of the loop. This is a particularly straightforward and mechanically robust method of controlling the size of the loop.

A fifth aspect of the invention provides an end effector for a robotic arm, the end effector having a plurality of fingers extending outwardly from a central node, one or more of the fingers being movable by a drive system to grasp an object between the plurality of fingers, wherein the end effector further comprises a position sensor at the central node, the position sensor being configured to detect a position of an object to be grasped by the plurality of fingers, wherein the drive system is controllable to move the one or more fingers to grasp an object in response to detection of the object by the position sensor.

In this way, the accuracy of positioning of the end effector with respect to an object to be grasped can be maximised.

The invention also provides a robotic arm comprising an end effector according to the third, fourth or fifth aspects. For example, the robotic arm may comprise a modular robotic arm according to the first aspect, and the second module may comprise an end effector according to the third, fourth or fifth aspects. The invention may further provide a system for harvesting fruit or vegetables comprising a movable base supporting one or more such robotic arms. The invention may also provide a kit of parts including a robotic arm and a plurality of end effectors according to the third, fourth and/or fifth aspects.

The invention also provides a system for harvesting fruit or vegetables including a first robotic arm comprising an end effector according to the third aspect and a second robotic arm comprising an end effector according to the fourth or fifth aspects, the second robotic arm being configured to control the end effector to grasp a fruit or vegetable to be harvested, and the first robotic arm being configured to control the end effector to use the cutting portion to cut a stem of the clamped fruit or vegetable.

The following features may be applied to any aspect of the invention, either individually or in any combination.

The variable stiffness actuator may comprise first and second variable stiffness actuators that can be independently operated. The first and second variable stiffness actuators may be operated in a high stiffness mode (antagonist mode) in which they counter-act each other by operating so that they oppose one another; this arrangement provides a relatively high joint stiffness and relatively low passive compliance (i.e. the joint has a relatively high resistance to deflection resulting from an externally applied torque).

In particularly preferred embodiments the first and second variable stiffness actuators are each bi-directional actuators. That is each bi-directional actuator is operable in a first configuration to urge the joint in a first direction, and in a second configuration to urge the joint in a second direction opposite to the first direction. In such arrangements, in addition to the high stiffness mode, the bi-directional actuators may also be operable in a cooperating mode (high torque mode) in which they work in tandem to double the available torque output; this arrangement provides a relatively low joint stiffness and a relatively high passive compliance (i.e. the joint has a relatively low resistance to deflection resulting from an externally applied torque).

The first and second bi-directional actuators may each comprise first and second resilient members of the one or more resilient members, an increase in tension in the first resilient member (i.e. operation in the first configuration) causing movement of the joint in a first direction and an increase in tension in the second resilient member (i.e. operation in the second configuration) causing movement of the joint in a second direction opposite to the second direction.

The first and second resilient members may each have a monotonically increasing non-linear relationship between applied force and resulting elongation. Thus, the relatively high stiffness in the high stiffness/antagonist mode results from the combined effects of the non-linear force-deflection relationship of the first and second resilient members.

The resilient members may each comprise an elastic element, tendon or other resilient member that can be stretched (elongated) to increase tension therein and thereby urge the joint to move.

In some embodiments the one or more resilient members comprise a composite material having a generally elastic portion and a relatively stiff portion. The composite material of the resilient members provides a particularly suitable form for the resilient members because the generally elastic portion enables a high degree of elongation, while the relatively stiff portion provides a limit to the possible elongation. Importantly, the elastic portion also provides inherent damping. Such damping reduces the amplitude of oscillations in the joint resulting from a movement of that joint.

The generally elastic portion may exhibit one or more elastic characteristics, such as an ability to deform (e.g. elongate) under an applied tension and vice versa, and to return to its original shape and size upon removal of the tension. The generally elastic portion may exhibit one or more characteristics of rubber elasticity, such as a cross-linked polymer chain that permits elongation of the generally elastic portion but that provides a restoring force which acts to urge it to its un-elongated configuration upon removal of the applied force.

The relatively stiff portion may also elongate under an applied tension. Preferably, its stiffness (i.e. its resistance to elongation) increases with elongation. Thus, the relatively stiff portion preferably provides an increase in stiffness of the respective resilient member with elongation of the resilient member.

Together the generally elastic portion and relatively stiff portion provide the resilient member with an ability to elongate under an applied tension and return to its original length upon removal of the tension, combined with a relationship between elongation and applied force (tension) in which its stiffness (i.e. its resistance to elongation) increases with elongation of the resilient member.

In preferred embodiments the composite material is configured in such a way that, as the resilient member is elongated, the elastic portion initially carries the majority of the load, but as the elongation increases the relatively stiff portion carries a progressively higher proportion of the load to provide an increasing resistance to further elongation.

In preferred embodiments the elastic portion comprises a core of the composite material and the relatively stiff portion comprises an outer surrounding portion. The relatively stiff portion preferably has a configuration that exhibits lateral contraction in response to longitudinal elongation. This arrangement is particularly suitable for providing an initial low resistance to elongation and progressive increase in resistance to elongation as elongation increases. That is, when the resilient member is subjected to an elongating force, the consequential longitudinal elongation of the relatively stiff portion results in a lateral contraction thereof. This lateral contraction is resisted by the elastic portion at the core of the composite material, and it is this resistance and the consequential deformation of the elastic portion that causes the progressive increase in resistance to elongation. As an example of such a configuration, the relatively stiff portion may comprise a spiral of material encasing the elastic portion. Alternatively, the relatively stiff portion may comprise a mesh sheath or other similar structure.

The elastic portion preferably comprises an elastomer, such as a thermoplastic elastomer. The relatively stiff portion preferably comprises a polymer, such as a thermoplastic polymer.

The resilient members provide the joint with a controllable degree of passive compliance. That is, the overall resistance of the joint to deflection resulting from an externally applied torque can be controlled. The claimed arrangements are therefore considered to be particularly suitable for operation in un-structured or partially un-structured environments with unreliable sensory information.

An example of such an environment is selective robotic harvesting of fruits and vegetables for fresh consumption. In such environments the sensory information is typically fast-changing because of the uncontrolled nature of the environment (e.g. moving targets due to wind, rain etc.) and the inherently noisy nature of the environment (e.g. varying amounts of sunlight).

Throughout the description and claims of this specification, the words “comprise” and “contain” and variations of the words, for example “comprising” and “comprises”, mean “including but not limited to”, and do not exclude other components, integers or steps. Moreover the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention will now be described, by way of example only, with reference to the accompanying drawings, in which:

FIG. 1 is a side view of a robotic arm according to an embodiment of the invention;

FIG. 2 is an isometric view of the robotic arm of FIG. 1;

FIG. 3 is an isometric view of a wrist joint module suitable for use in embodiments of the invention;

FIG. 4 is a plan view of the wrist joint module of FIG. 3;

FIG. 5 is a side view of the wrist joint module of FIG. 3;

FIG. 6 is an isometric view of a driver pulley wheel of the wrist joint module of FIG. 3;

FIGS. 7A-D are various views of a driven pulley wheel of the wrist joint module of FIG. 3;

FIG. 8 illustrates a resilient member suitable for use in embodiments of the invention;

FIG. 9 is an isometric view of an end effector module suitable for use in embodiments of the invention;

FIG. 10 is a partial view of the end effector module of FIG. 9 with a top cover part omitted to enable the cutting wire to be seen;

FIGS. 11-13 are views of a drive system of the end effector module of FIG. 9;

FIG. 14 is an isometric view of an end effector module suitable for use in embodiments of the invention;

FIG. 15 shows the end effector module of FIG. 14 with the belt omitted;

FIGS. 16A-C are views of a drive system of the end effector of FIG. 14;

FIGS. 17A and 17B schematically illustrate a trajectory carried out by an end effector of a robotic arm according to an embodiment of the invention, and a change in stiffness of one or more joints within that arm during movement through the trajectory, respectively;

FIGS. 18A and 18B illustrate embodiments of control architecture for a ballistic phase (FIG. 18A) and a closed-loop joint control phase (FIG. 18B) of movement of one or more joints of a robotic arm according to an embodiment of the invention;

FIG. 19 illustrates a fruit- or vegetable-picking system incorporating multiple robotic arms according to an embodiment of the invention;

FIGS. 20A and 20B illustrate an alternative elbow joint module suitable for robotic arms according to embodiments of the invention, the elbow joint module having swappable driver pulley wheels;

FIGS. 21A and 21B are side views of the elbow joint module of FIG. 20A;

FIG. 22 is a side view of the elbow joint module of FIG. 20A with the driver pulley wheel removed; and

FIG. 23 is an isometric view of a portion of the elbow joint module of FIG. 20A with one of the driver pulley wheels omitted for clarity.

### DETAILED DESCRIPTION

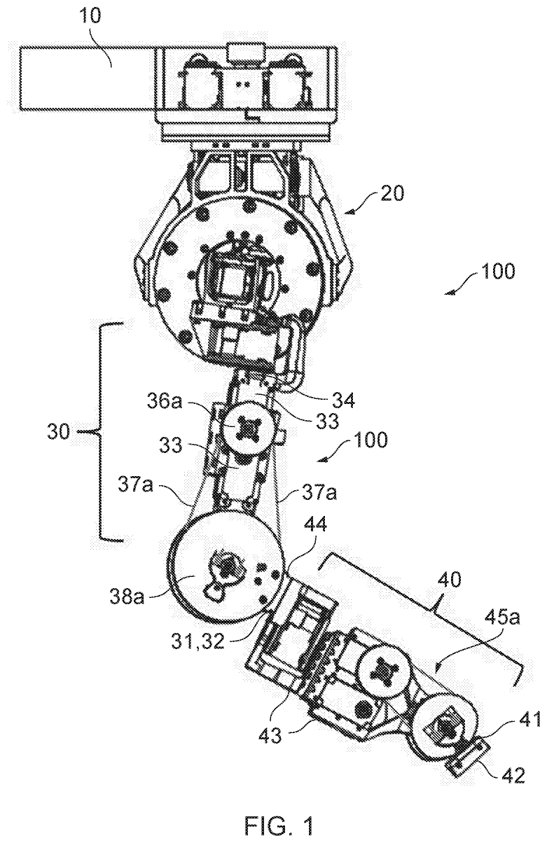

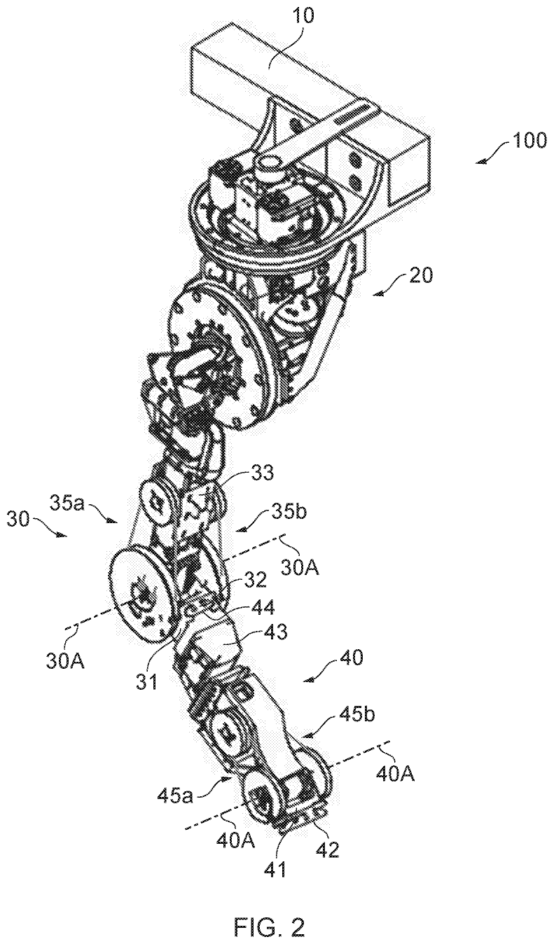

FIGS. 1 and 2 illustrate side and isometric views, respectively, of a robotic arm 100 according to an embodiment of the invention. The arm comprises a base 10 via which the arm 100 can be mounted to a structure, and via which the arm can receive an electricity supply (not shown) and/or control signals.

The arm 100 has a plurality of articulated joints, including a shoulder joint 20, an elbow joint 30, and a wrist joint 40.

The joints together provide movement with six degrees of freedom; in Cartesian space this corresponds to displacement along x, y and z axes, and rotation about each of the x, y and z axes. Movement of the joints controls the position and orientation of the end effector 50 (not shown in FIGS. 1 and 2) to thereby enable an object to be manipulated by the end effector.

The wrist joint 40 enables relative movement about an axis 40A between a rigid first link 41 that extends towards the end effector 50 and a rigid second link 43 that extends towards the elbow joint 30. The first link 41 comprises an end effector connector 42 configured to enable an end effector 50 (not shown in FIGS. 1 and 2) to be removably attached to the arm 100 via a rigid connection, and the second link 43 comprises an elbow connector 44 configured to enable the second link 43 to be removably attached to the elbow joint 30. The wrist joint 40 thus comprises a wrist joint module.

Similarly, the elbow joint 30 enables relative movement about an axis 30A between a rigid third link 32 that extends towards the wrist joint 40 and a rigid fourth link 34 that extends towards the shoulder joint 20. The third link 32 comprises an elbow connector 33 configured to be removably engaged with the elbow connector 44 of the second link 43 to provide a rigid connection between the third 32 and second 43 links. The fourth link 34 comprises a shoulder connector 35 configured to be removably engaged with a corresponding connector of the shoulder joint to enable the fourth link 34 to be removably attached to the shoulder joint 20. The elbow joint 30 thus comprises an elbow joint module.

The shoulder joint 20 forms a shoulder joint module, and will not be described in detail herein. The skilled reader will readily understand how the principles described in relation to the elbow and wrist joints may be applied to the shoulder joint 20, or to any other joint in the robotic arm 100.

The shoulder joint 20, elbow joint 30 and wrist joint 40 each comprise a variable stiffness joint which enables the passive compliance of the joint (i.e. the resistance to deflection resulting from an externally applied force/torque) to be controlled. The principles of the variable stiffness joint will be described below in relation to the elbow joint 30 and wrist joint 40, though the skilled reader will readily understand how these principles may be applied to the shoulder joint 20 or to any other joint in the robotic arm 100.

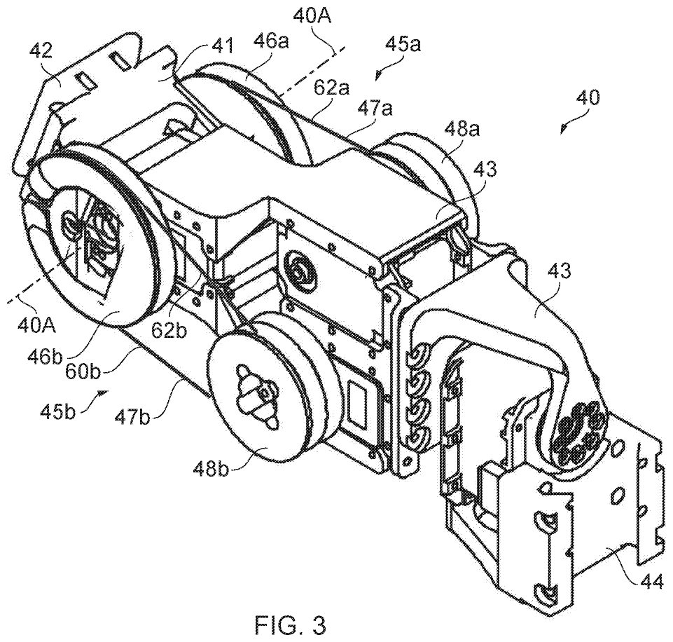

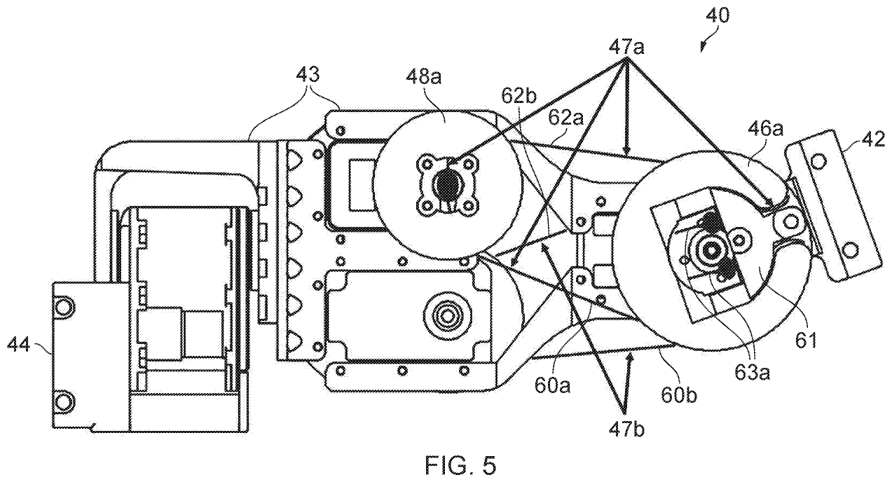

In the wrist joint 40, which can be seen most clearly in FIGS. 3-7, relative movement between the first 41 and second 43 links is controlled by first 45a and second 45b bi-directional actuators that together enable the wrist joint 40 to act as a variable stiffness joint. Each bi-directional actuator 45a, 45b comprises a motor (not shown) driving a driver pulley wheel 46a, 46b rigidly connected to the first link 41 but rotatable relative to the second link 43, each driver pulley wheel engaging a flexible actuation link 47a, 47b. The actuation links 47a, 47b each comprise a pliable elongate cord that extends in a continuous loop between the driver pulley wheel 46a, 46b and a driven pulley wheel 48a, 48b to thereby enable each driver pulley wheel to drive its respective driven pulley wheel via a belt drive arrangement.

The driven pulley wheels 48a, 48b are each rotatably mounted on the second link 43. In this way, rotation of the driven pulley wheels 48a, 48b in response to rotation of the driver pulley wheels 46a, 46b causes relative movement between the first and second links, and thus movement of the wrist joint 40.

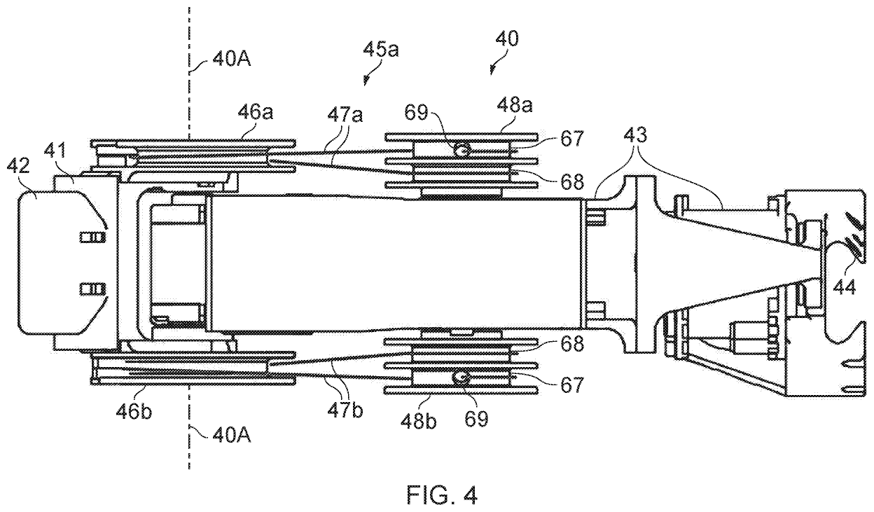

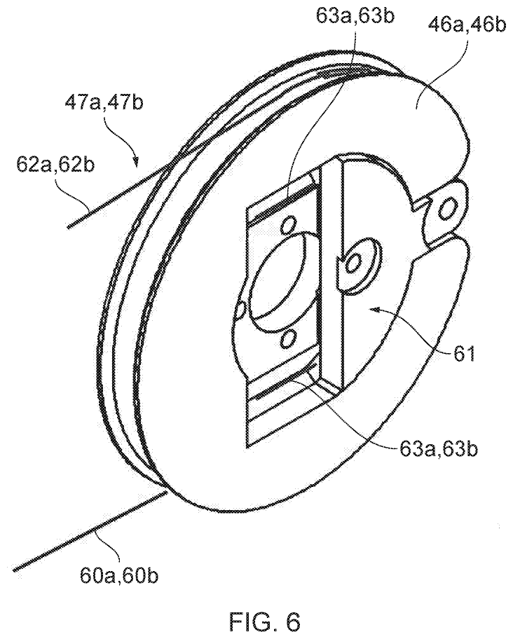

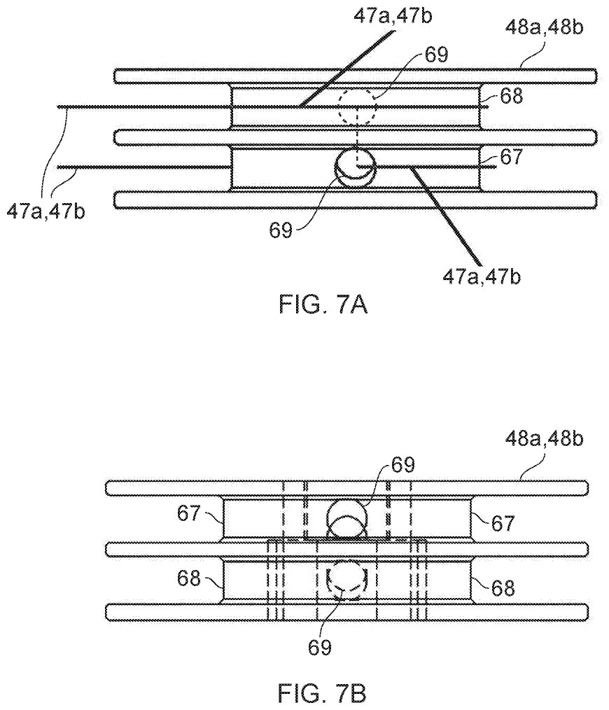

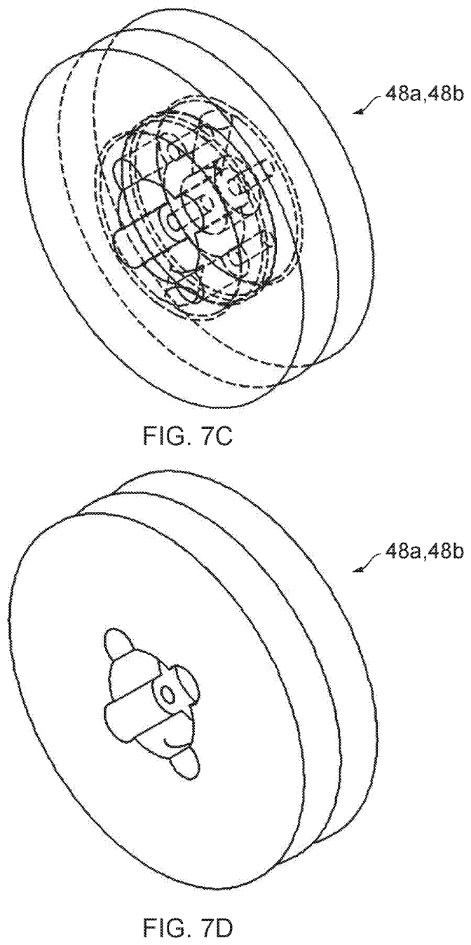

As shown best in FIGS. 4 and 7, the driven pulley wheels 48a, 48b each comprise a double pulley having two adjacent pulley tracks 67, 68 sharing a common rotational axis. Each actuation link 47a, 47b is fixed to its respective driver wheel 46a, 46b so that a portion of the actuation link moves in tandem with the driver wheel in an arc around the axis 40A. In the illustrated embodiment this is achieved by clamping two free ends 63a, 63b of the elongate actuation link between the driver wheel and a clamp member 61 as shown in FIG. 6, but in other embodiments each actuation link may comprise a continuous loop clamped or otherwise fixed to the driver wheel. Each actuation link 47a, 47b then extends around a first pulley track 67 of the respective driven pulley wheel 48a, 48b through a passageway 69 to the second pulley track 68, and from there around the second pulley track 68 and back to the driver wheel 46a, 46b.

This double pulley arrangement provides a doubled torque output compared to a single pulley arrangement. However, arrangements in which the driven pulley wheels 48a, 48b comprise single pulley wheels are encompassed by this application.

In some embodiments each actuation link comprises a loop having two generally non-extensible portions that engage the driver and driven pulley wheels, respectively, a first tendon portion 60a, 60b (also referred to as a first resilient member 60a, 60b) that extends between the driver and driven pulley wheels, and a second tendon portion 62a, 62b (also referred to as a second resilient member 62a, 62b) that extends between the driver and driven pulley wheels. In other embodiments the actuation links may not comprise any generally non-extensible portions.

The first 60a, 60b and second 62a, 62b tendon portions each have a monotonically increasing non-linear relationship between applied force and resulting elongation. That is, the resistance to elongation (stiffness) increases with increased applied force.

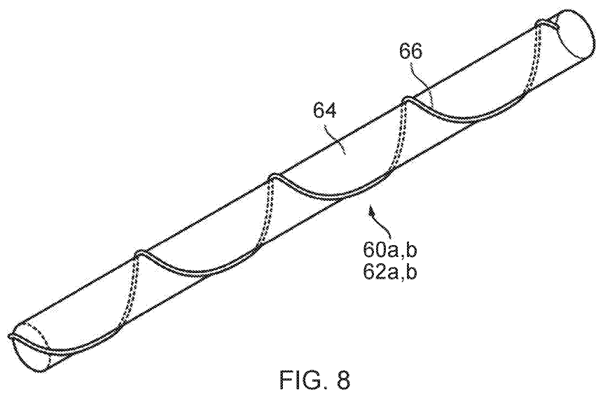

An embodiment of the first 60a, 60b and second 62a, 62b tendon portions is illustrated in FIG. 8. Each tendon portion comprises an elongate elastic core 64 around which a helical- or spiral-shaped stiffening portion 66 is wrapped. The elastic core 64 has a circular cross-section and is formed from an elastomeric material that is able to provide a significant degree of elongation (e.g. up to 700% increase in length) when under tension and return to its original shape and size when the tension is removed. An appropriate material for the elastic core 64 is a TPE thermoplastic elastomer such as Filaflex™, produced by Recreus. In contrast, the material from which the stiffening portion 66 is made is generally non-elastic; a suitable material is nylon.

When an elongating tensile force is applied to each of the tendons, the spiral shape of the stiffening portion 66 means that it becomes longer in the longitudinal direction (the direction in which the force is applied) while becoming narrower in the lateral direction (perpendicular to the longitudinal direction). This lateral contraction is resisted by the elastic core 64, and this resistance and the consequential deformation of the elastic portion causes a progressive increase in resistance to elongation with an increase in applied force. In this way, as the tendon is elongated, the elastic portion initially carries the majority of the load, but as the elongation increases the relatively stiff portion carries a progressively higher proportion of the load to provide an increasing resistance to further elongation.

In use, each bi-directional actuator 45a, 45b is able to provide movement of the wrist joint 40 in both a first direction (clockwise movement of the second link 43 relative to the first link 41, as seen in FIGS. 1 and 2) and a second direction opposite to the first direction. Movement in the first direction is caused by operating the motor to turn each driver pulley 46a, 46b to thereby increase tension in the first tendon portion 62a, 62b and thereby reduce tension in the second tendon portion 64a, 64b. Similarly, movement in the second direction is caused by operating the motor to turn each driver pulley 46a, 46b to increase tension in the second tendon portion 64a, 64b and thereby reduce tension in the first tendon portion 62a, 62b.

In this way, each of the bi-directional actuators 45a, 45b is operable in a first configuration to urge the wrist joint 40 in the first direction, and in a second configuration to urge the joint in the second direction. By controlling movement of the joint via independent control of both the first 45a and second 45b bi-directional actuators it is possible to vary the stiffness (the resistance to externally-applied forces) of the joint while controlling its position.

That is, in a high torque mode (cooperating mode) each of the bi-directional actuators 45a, 45b may be operated to work in tandem (i.e. both in the first configuration or second configuration) to maximise the available torque output. In this mode the joint has a relatively low stiffness and relatively high passive compliance. At the other end of the spectrum, the bi-directional actuators 45a, 45b may be operated in a high stiffness mode (antagonist mode) in which they counter-act each other (i.e. one in the first configuration and the other in the second configuration). In this mode the joint has a relatively high stiffness and relatively low passive compliance.

The bi-directional actuators 45a, 45b can also be operated at any point along the continuous spectrum between the high torque mode and high stiffness mode, so that as the stiffness of the joint is reduced the available torque output can be increased, and vice versa. In this way, when low joint stiffness is required (such as during ballistic phase movements described below) the torque output of the joint can be maximised.

The relationship between the first 45a and second 45b bi-directional actuators can be described by way of the differential position, p, of the driver pulleys 46a, 46b. That is, in the high torque mode the differential position may have a maximum value of ‘1’, in the high stiffness mode a maximum value of ‘−1’, and values between ‘1’ and ‘−1’ may represent differential positions in the spectrum between these extremes.

In alternative embodiments, each of the bi-directional actuators 45a, 45b may be replaced by a uni-directional actuator (not illustrated). For example, the first uni-directional actuator 45a may comprise only the first tendon portion 60a and no second tendon portion, and the second uni-directional actuator 45b may comprise only the second tendon portion 62b and no first tendon portion. In this way, movement of the wrist joint 40 in the first direction may be achieved by operating the driver pulley 46a of the first uni-directional actuator 45a to increase tension in the first tendon portion 60a, and movement of the wrist joint 40 in the second direction may be achieved by operating the driver pulley 46b of the second uni-directional actuator 45b to increase tension in the second tendon portion 62b. Moreover, the first and second uni-directional actuators may be operated together to control the overall stiffness of the wrist joint 40 in a similar manner to that described above in relation to the high stiffness mode (antagonist mode) of the bi-directional actuator embodiment.

Each of the joints of the arm 100, including the shoulder joint 20, and elbow joint 30 may have a variable stiffness joint as described above in relation to the wrist joint 40. The wrist joint 40 is described merely as being exemplary of any variable stiffness joint in the arm 100.

In particular, the elbow joint 30 is broadly similar to the wrist joint 40, and for that reason description herein will focus on the features of the elbow joint 30 that are different.

In the elbow joint 30, relative movement between the third 32 and fourth 34 links is controlled by first 35a and second 35b bi-directional actuators that together enable the elbow joint 30 to act as a variable stiffness joint. Each bi-directional actuator 35a, 35b comprises a motor (not shown) driving a driver pulley wheel 36a, 36b rotatably mounted on the fourth link 33, each driver pulley 36a, 36b engaging a flexible actuation link 37a, 37b. The actuation links 37a, 37b each comprise a pliable elongate cord that extends in a continuous loop between the driver pulley wheel 36a, 36b and a driven pulley wheel 38a, 38b to thereby enable each driver pulley wheel to drive its respective driven pulley wheel via a belt drive arrangement.

The driven pulley wheels 38a, 38b are each rigidly connected to the third link 31 but rotatable relative to the fourth link 33. In this way, rotation of the driven pulley wheels 38a, 38b in response to rotation of the driver pulley wheels 36a, 36b causes relative movement between the third and fourth links, and thus movement of the elbow joint 30.

The first 35a and second 35b bi-directional actuators are identical to the first 45a and second 45b bi-directional actuators of the wrist joint 40, with the exception that the driven pulleys 38a, 38b of the elbow joint 30 comprise single pulleys, rather than double pulleys. In other respects, the features of the actuators, including the actuation links thereof, and how they may be operated, described above in relation to the wrist joint 40 apply equally to the elbow joint 30.

In the illustrated embodiments each of the connectors, including the end effector connector 42, elbow connectors 32, 44, and shoulder connector 34, comprise sliding dovetail joint connection features. In more general terms each pair of cooperating connectors, one connector comprises a male protruding feature and the other connector comprises a female feature with which the male feature can be engaged to provide a rigid connection therebetween. The male feature generally comprises a protruding portion that tapers outwardly in a width direction and the female feature generally comprises a recess that tapers inwardly in a corresponding manner to provide a close sliding fit therebetween.

The skilled reader will understand that the specific shape and configuration of the male and female features are not critical, the important feature being that they can be readily interconnected via a one-step connection step to provide a rigid connection therebetween and readily disconnected subsequently.

The end effector 50 comprises an end effector module that can be integrated into the robotic arm 100 by interlocking the wrist connector 52 of an end effector 50 (see below) with the end effector connector 42 of the wrist joint 40.

The wrist joint 40 comprises a wrist joint module that can be integrated into the robotic arm 100 by interlocking elbow connectors 34, 44, and interlocking end effector connector 42 with a corresponding wrist connector 52 of an end effector 50 (see below).

Similarly, the elbow joint 30 comprises an elbow joint module that can be integrated into the robotic arm 100 by interlocking elbow connectors 34, 44, and interlocking shoulder connector 35 with a corresponding elbow connector of the shoulder joint.

Finally, the shoulder joint 20 comprises a shoulder joint module that can be integrated into the robotic arm 100 by interlocking respective connectors thereof with corresponding connectors of the base 10 and elbow module.

This arrangement enables the robotic arm 100 to be modular such that each of the joint modules 20, 30, 40 can be swapped out for a replacement joint, and the end effector 50 can be swapped out for a replacement end effector.

For example, each joint module may be removed and replaced with an equivalent joint module to cater for maintenance requirements or in-service faults, or it may be replaced with a joint module in which the actuators provide a different level of torque or speed output to allow the operating characteristics of the arm 100 to be tuned for different operating conditions.

Similarly, the end effector module 50 may be swapped out for an equivalent replacement end effector module to cater for maintenance requirements or in-service faults, or alternatively may be replaced with an end effector having different functionalities. For example, an end effector module having fingers suitable for grasping a fruit or vegetable to enable it to be picked may be swapped for an end effector module, such as end effector module 50A described below, having a blade suitable for cutting the stem of a fruit or vegetable.

A key feature that enables this modular arrangement is that no actuation links extend across any connector or pair of cooperating/interlocking connectors. Thus, a whole joint module can be removed and replaced without the need to remove, alter or otherwise adjust the bi-directional actuators or their actuation links. Indeed, the removal of a module should be possible simply by disconnecting its connector(s).

In variations of the illustrated embodiments the torque vs. speed characteristics of any of the joints 20, 30, 40 may be varied by modifying the effective diameter of the driver and/or driven wheel pulleys of the respective actuators. Thus, the gear ratio—i.e. the ratio between the track diameter of the driven pulley wheel and driver pulley wheel—of each actuator can be varied.

This may be achieved in a number of different ways. For example, one or more of the pulleys may be swapped with another pulley having a different effective diameter (i.e. in which the track around which the actuation links pass has a different diameter). Alternatively, one or more of the pulleys may comprise a plurality of tracks about which the actuation links can pass, each track having a common axis but a different diameter, so that the actuation link can be swapped between the tracks. Finally, one or more of the pulleys may comprise a track with a variable diameter; for example, the track may comprise multiple separate regions that can move in a radial direction to increase or decrease the overall track diameter.

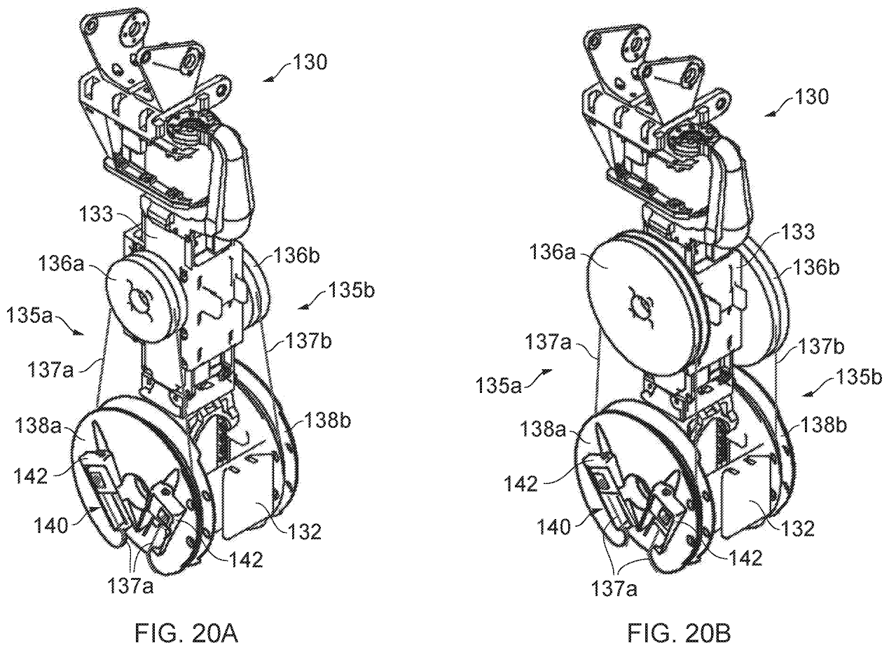

Taking the elbow joint 30 as an example, the driver pulley wheels 36a, 36b of the bi-directional actuators 35a, 35b may be exchanged or otherwise modified to provide a larger or smaller track diameter to thereby alter the ratio between the diameter of the driver pulley wheels 36a, 36b and the driven pulley wheels 38a, 38b. Such an arrangement is illustrated in FIGS. 20 to 23, which show an elbow joint 130 that can be exchanged with the elbow joint 30 of the embodiment illustrated in FIGS. 1 to 9.

In FIG. 20A the driver pulley wheels 136a, 136b of the elbow joint 130 have a relatively small diameter to provide a relatively high torque output, while in FIG. 20B the driver pulley wheels 136a, 136b have been replaced with equivalent pulley wheels with a relatively large diameter to thereby provide a relatively high speed output. The driven pulley wheels 138a, 138b each incorporate a tension control mechanism 140 by which the effective length of the respective actuation link 137a, 137b—and thus the tension therein—can be readily and straight-forwardly controlled when the driver pulley wheels 136a, 136b are exchanged for a smaller or larger pulley wheel.

The tension control mechanism 140 of each driven pulley wheel 138a, 138b comprises a pair of slider mechanisms 142, each of which has a slider 144 that clamps a free end of the actuation link 137a, 137b, the slider 144 being slidable within a slider block 146. As the slider 144 slides within the slider block 146 the free end of the actuation link 137a, 137b is moved to thereby alter its overall length and thus the tension therein. The position of the slider 144 within the slider block 146 is controlled by rotation of a screw 148 comprising a male screw thread which cooperates with a female screw thread in the slider 144.

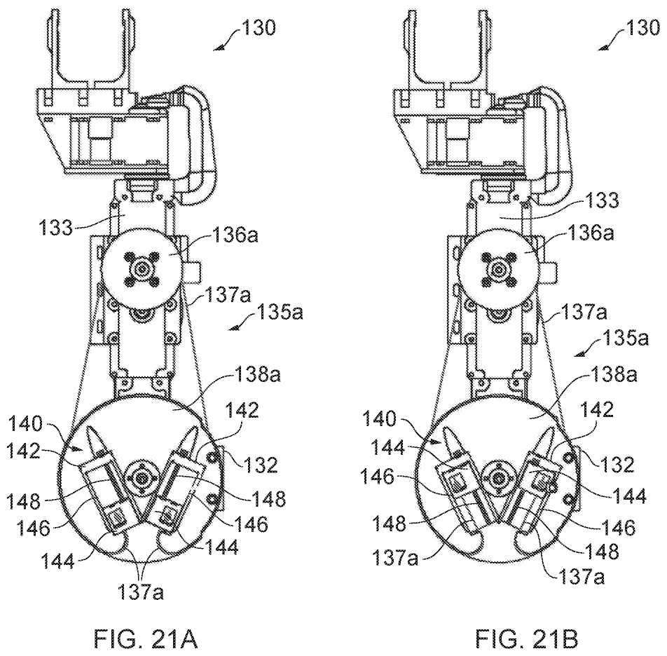

Thus, the tension on the actuation link 137a, 137b can be readily modified simply by rotation of the screw 148 of one or both of the sider mechanisms 142. FIG. 21A illustrates the tension control mechanism 140 in a pre-tensioned configuration, while FIG. 21B illustrates the mechanism after tensioning by sliding the sliders 144 along their respective slider blocks 146.

Each slider 144 can be removed from its respective slider block 146 by rotating the screw 148 until it is disconnected from the slider 144. The uninstalled slider 144 is then connected to the actuation link 137a, 137b but otherwise unconnected to the driven pulley wheel 138a, 138b. To remove the driver pulley wheels 136a, 136b the tension control mechanisms 140 are used to reduce the tension in each of the actuation links 137a, 137b by sliding each of the sliders 144 along their respective slider blocks 146 to the position illustrated in FIG. 21A. The sliders 144 are then removed from their respective slider blocks 146 entirely so that there is no connection between the actuation link 137a, 137b and the driven pulley wheel 138a, 138b.

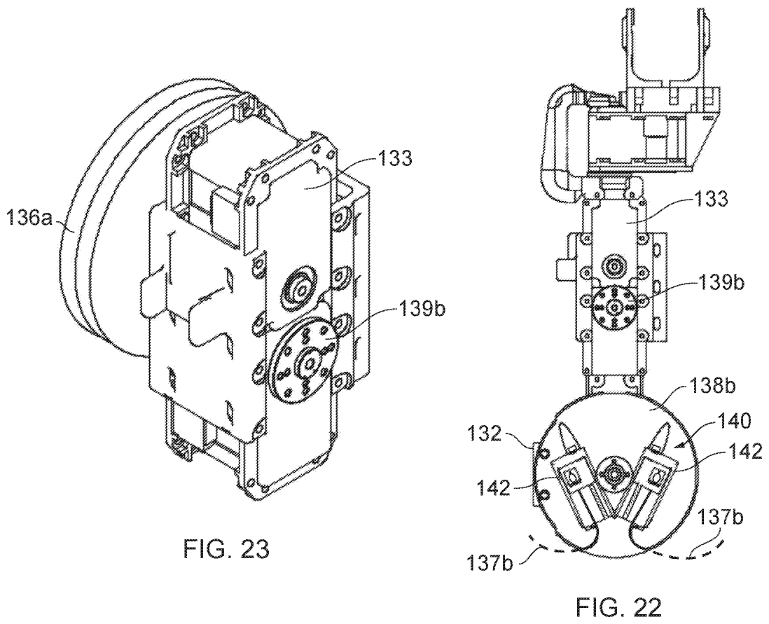

The driver pulley wheels 136a, 136b are then removed as shown in FIG. 22 and the actuation links 137a, 137b are removed with them (FIG. 22 illustrates an arrangement in which the driver pulley wheels 136a, 136b are removed before the sliders 144 are removed from the slider blocks 146, but it is envisaged that these steps will more likely be carried out in the reverse order). FIG. 23 shows in more detail the mounting plate 139b to which the driver pulley wheel 136b fastens. Each mounting plate 139a, 139b provides an interface between the motor enclosed within the fourth link 133 whereby the motor is operable to rotate the mounting plate 139a, 139b.

The driver pulley wheels 136a, 136b are then replaced with pulley wheels having a different effective diameter by fastening the replacement driver pulley wheels to their respective mounting plates 139a, 139b. The actuation links 137a, 137b are also replaced with corresponding replacement actuation links having a different effective length appropriate to the diameter of the replacement pulley wheels. In preferred arrangements each of the original or replacement actuation links is durably connected to its respective original or replacement driver pulley wheel. For example, the driver pulley wheels 136a, 136b may comprise double pulleys of the type described above in relation to driven pulley wheels 48a, 48b illustrated in FIGS. 4, 6 and 7, in which the actuation links are clamped to the pulley wheel.

The replacement actuation links each have a replacement slider corresponding to the sliders 144 connected to a free end thereof. Once the replacement driver pulley wheels have been installed, the replacement sliders are each installed in their respective slider blocks 146 and the tension control mechanisms 140 then used to increase the tension therein to an operating tension by sliding each of the sliders 144 along their respective slider blocks 146 to, or towards, the position illustrated in FIG. 21B.

The end effector module 50 may be selected from a set of end effector modules having end effectors with different characteristics suited to different applications. For example, a suitable end effector 50 for picking soft fruit may comprise two opposing rigid finger members with a pliable pad at a free end thereof, the finger members moveable in a pincer configuration to grip an object (not shown) between the pliable pads. Alternatively, the end effector may comprise a plurality of flexible fingers.

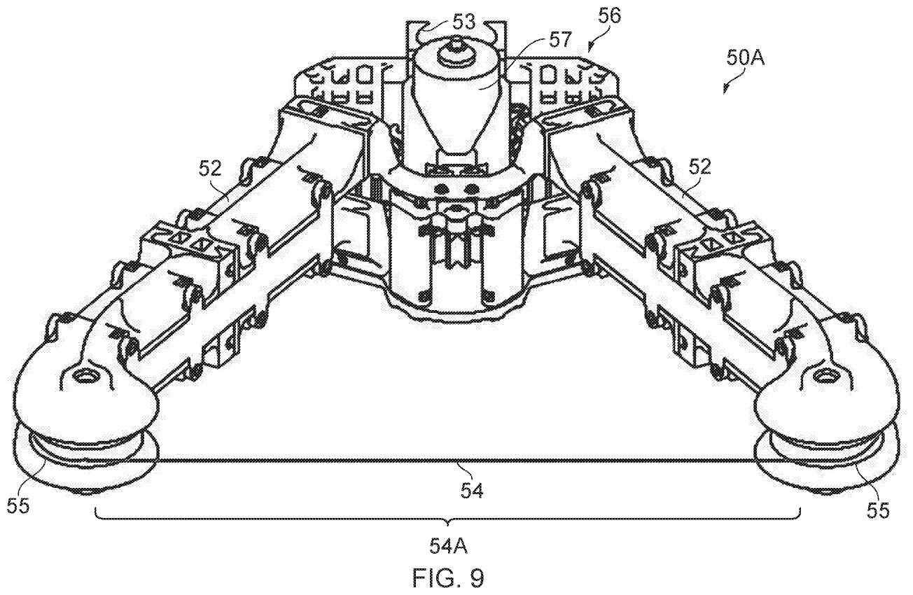

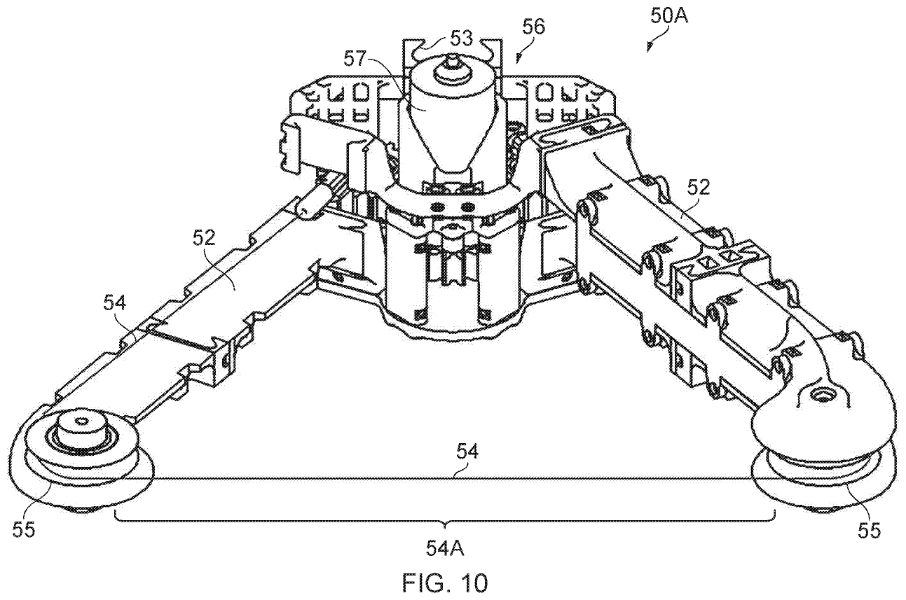

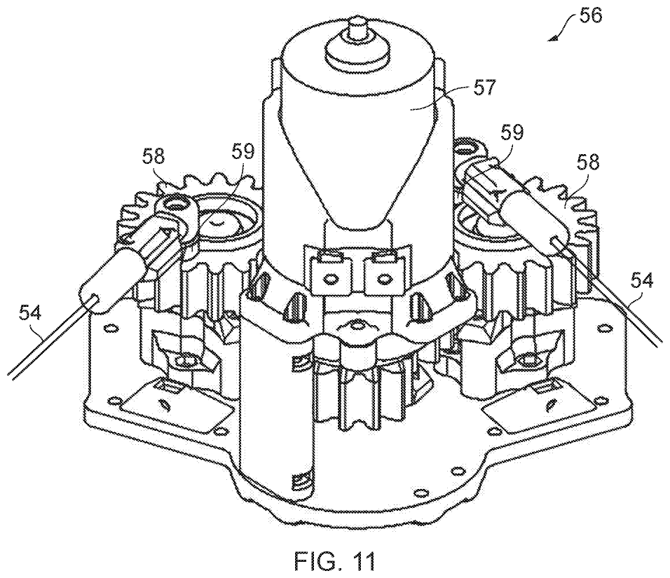

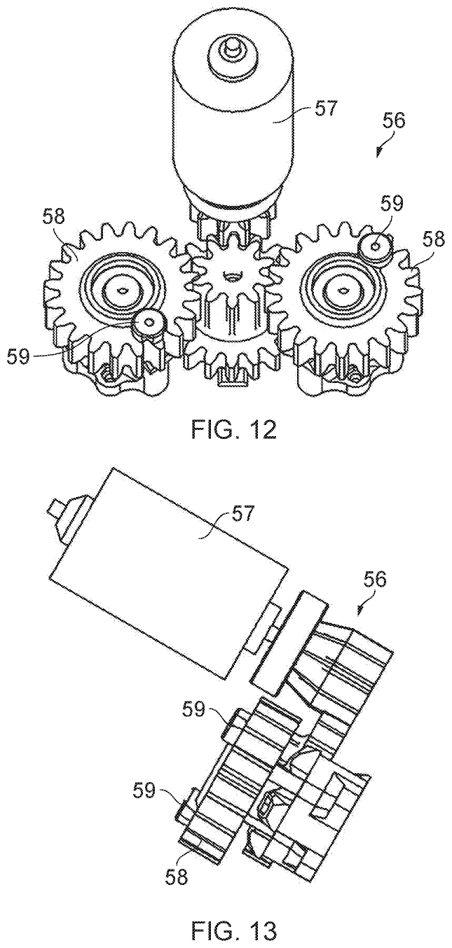

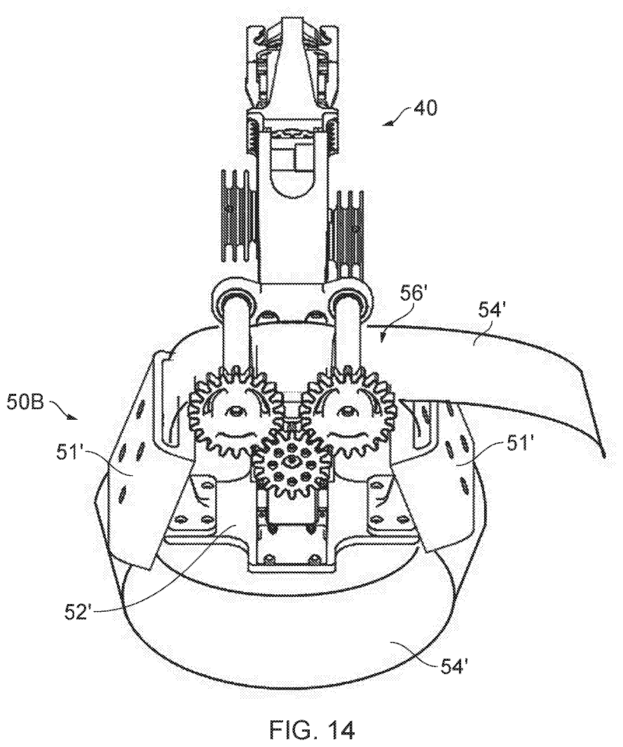

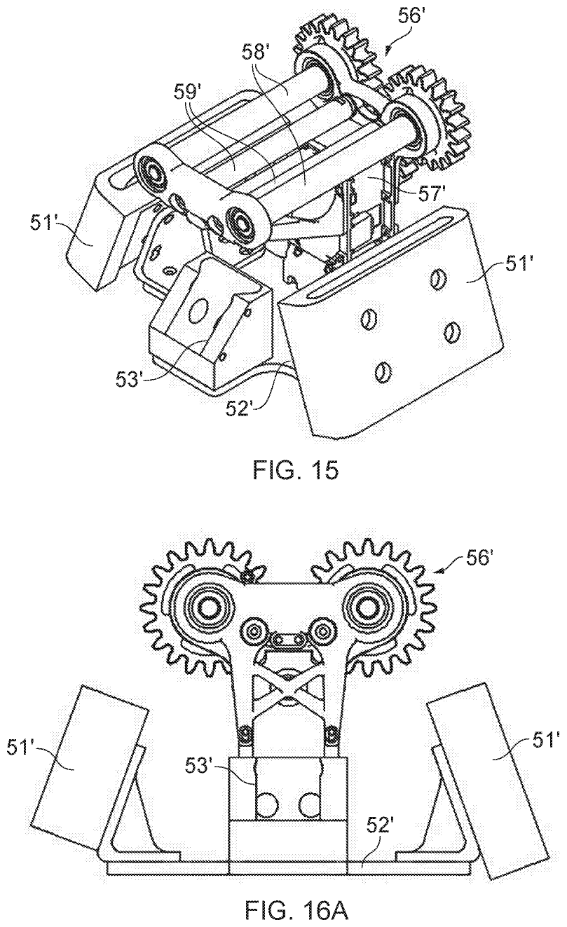

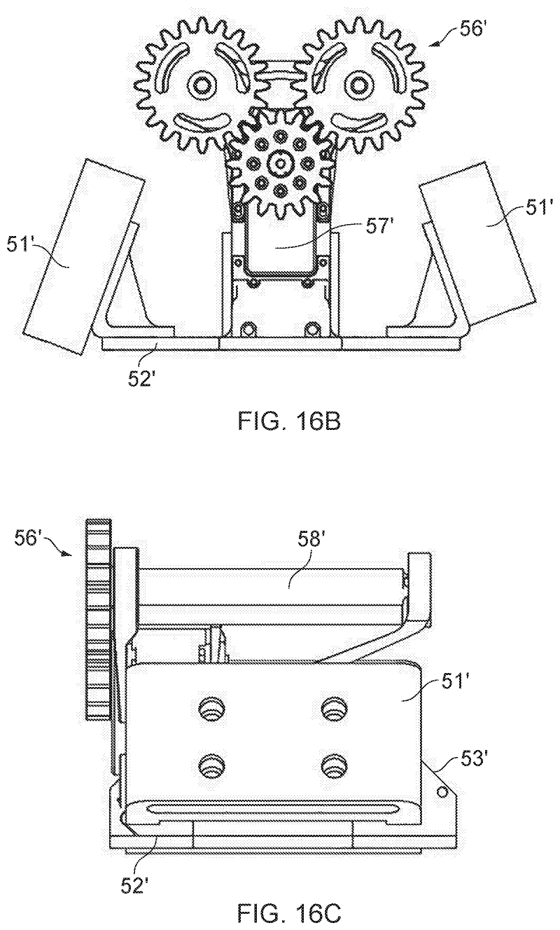

FIGS. 9 to 13 illustrate an end effector module 50A comprising a blade for cutting a stem of a fruit or vegetable, and FIGS. 14 to 16 illustrate a related end effector module 50B comprising a belt, or band, for grasping a fruit or vegetable while its stem is being cut.

The end effector blade module 50A comprises a rigid static portion 52 comprising a base portion with two diverging arms that together form a V-shape. The base portion includes a wrist connector 53 configured to interconnect with the end effector connector 42 to provide a rigid connection between the static portion 52 and the first link 41 of the arm 100. A cutting wire 54 extends around rotatable pulleys 55 at the free end of each arm of the static portion 52 to form a cutting portion 54A therebetween. The wire 54 then passes along each arm to a drive system 56 comprising a motor 57 that drives a pair of toothed gears 58 so that they rotate in tandem about aligned gear axes. Each free end of the cutting wire 54 is attached to a fixing location 59 on a respective one of the toothed gears 58 that is offset from the gear axis. In this way, as the toothed gears 58 rotate the cutting wire 54 reciprocates along its length. Thus, the wire in the cutting portion 54A moves in a sawing motion relative to the static portion 52 so that the cutting portion 54A can be urged against the stem of a vegetable or fruit to cut therethrough.

The cutting wire 54 is able to cut equally at all positions around its surface. In the present embodiment the cutting wire 54 comprises a braided wire in which four strands of steel wire are braided, or twisted, together, each strand comprising a wire core with a thinner steel wire wrapped around it in a helical arrangement. The thinner steel wire thus forms blunt, or rounded, protrusions that project radially from each wire core. These protrusions are thus harmless when the cutting wire 54 is not moving, but act as cutting teeth, or serrations, when the cutting wire 54 is reciprocated. The skilled reader will understand that other forms of cutting wire able to cut equally at all positions around its surface are available, and are appropriate for use in the present embodiment.

The belt module 50B comprises a rigid static portion 52′ including a base portion supporting a drive system 56′, two belt guides 51′, and a wrist connector 53′ configured to interconnect with the end effector connector 42 to provide a rigid connection between the static portion 52′ and the first link 41 of the arm 100. A belt 54′ extends in a loop between the belt guides 51′. One end of the belt 54′ is fixed and the other end comprises a free end that is movable relative to the fixed end by the action of the drive system 56′ to thereby increase or decrease the size of the loop. The drive system 56′ comprises a motor 57′ that drives a pair of driven rollers 58′. The belt 54′ passes between the driven rollers 58′ and a pair of passive rollers 59′ so that rotation of the driven rollers 58′ causes the free end of the belt to move relative to the fixed end.

In use, one robotic arm 100 comprising the belt module 50B is controlled so that the loop of the belt 54′ encircles a vegetable or fruit to be picked. The drive system 56′ is then operated to decrease the size of the loop and thereby grip the vegetable or fruit with the belt 54′. A second robotic arm 100 comprising the blade module 50A is controlled so that the cutting portion 54A of the cutting wire 54 is urged against a stem of the vegetable or fruit so that the reciprocating motion of the wire causes the cutting portion 54A to cut through the stem. The cut vegetable or fruit is then removed by the robotic arm comprising the belt module to a collection container and the drive system 56′ operated to increase the size of the loop of the belt 54′ to thereby release the vegetable or fruit.

In preferred embodiments the robotic arm 100 also comprises a sensor-control phase stereo camera (not shown) and colour camera (not shown) mounted on an end link of the arm (e.g. the first link 41 or a static portion of the end effector module) so that they move in tandem with the end effector 50. In this way, the sensor-control phase stereo camera and colour camera provide continuous images of the region of the environment within which the end effector 50 can operate, and a limited portion of the environment surrounding the end effector 50. The sensor-control stereo camera and colour camera are used in the sensor control (final approach) phase of movement of the robotic arm 100, as described further below.

In embodiments in which the end effector 50 comprises two or more fingers movable towards one another to grip an object the sensor-control phase stereo camera and/or colour camera may alternatively be mounted to a central region between the fingers to thereby provide a particularly close association between the location of the camera(s) and the end effector location.

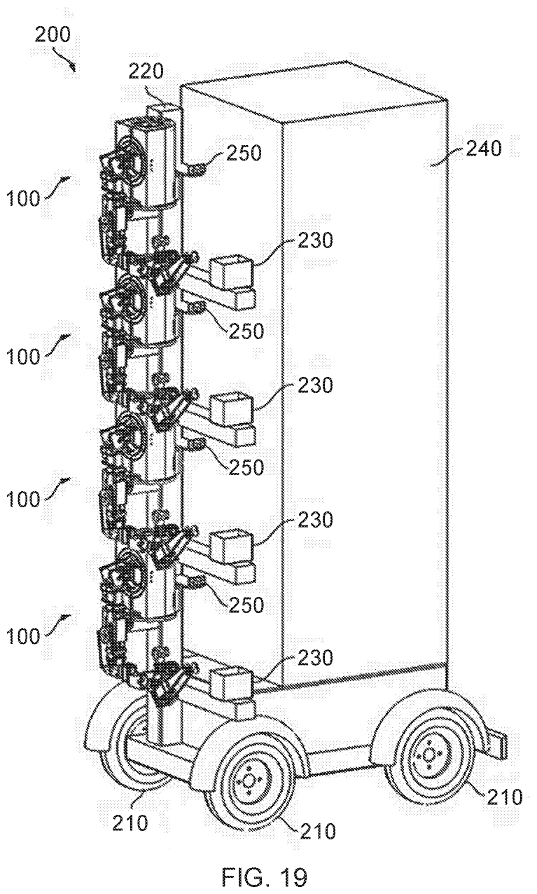

Each robotic arm 100 also has an associated joint control phase stereo camera (250 in FIG. 19; not shown in FIGS. 1 and 2) that is positioned in a fixed position with respect to the base 10, and provides images including all points accessible by the end effector 50 of that arm 100.

In use, the robotic arm 100 is controlled to control the position of the end effector 50 by controlling the position of each of the joints, including the wrist joint 40, elbow joint 30, and shoulder joint 20, while simultaneously controlling the stiffness of each of those joints.

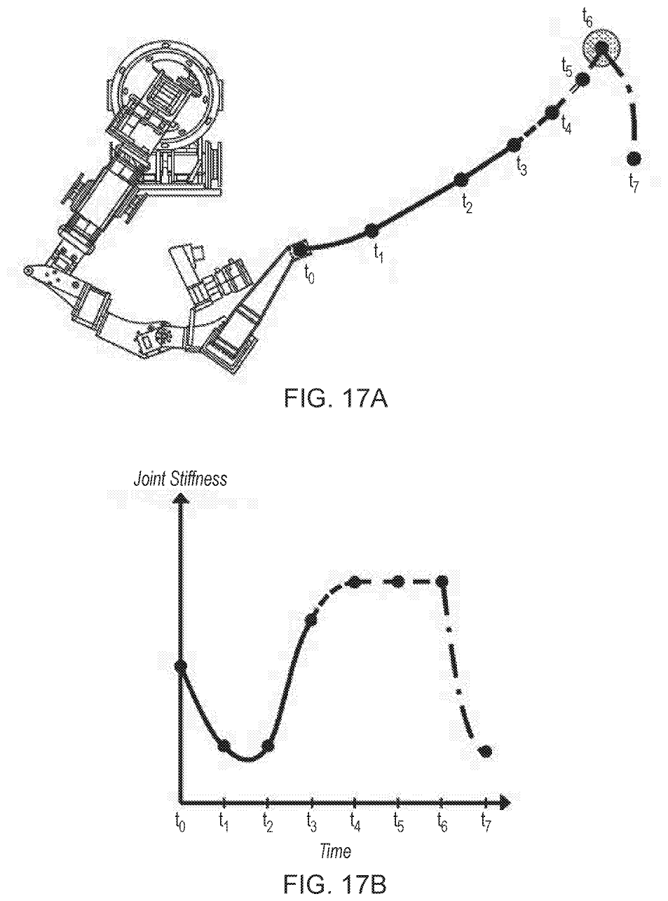

FIGS. 17A and 17B illustrate an embodiment of the invention in which the robotic arm 100 is controlled via a four-phase movement. This four-phase movement is considered to be particularly suitable for applications in which an object is to be engaged or otherwise manipulated by the end effector 50, such as fruit- or vegetable-picking applications.

FIG. 17A illustrates an example trajectory for a fruit- or vegetable-picking movement, while FIG. 17B schematically illustrates the change in joint stiffness at the elbow joint 30 (or shoulder joint 20, wrist joint 40, or other joint) over that trajectory. The end effector 50 starts at t₀ and travels in a ballistic phase through t₁ and t₂ to t₃. The trajectory from t₃ to t₄ represents a closed-loop joint control phase, while the trajectory from t₄ to t₆ represents a sensor-control phase. At t₆ the end effector 50 grasps, engages or otherwise manipulates the fruit or vegetable, and the trajectory from t₆ to t₇ represents an optional detachment phase where the fruit or vegetable is detached from the stem, cane, bush, vine, stem or tree on which it has grown.

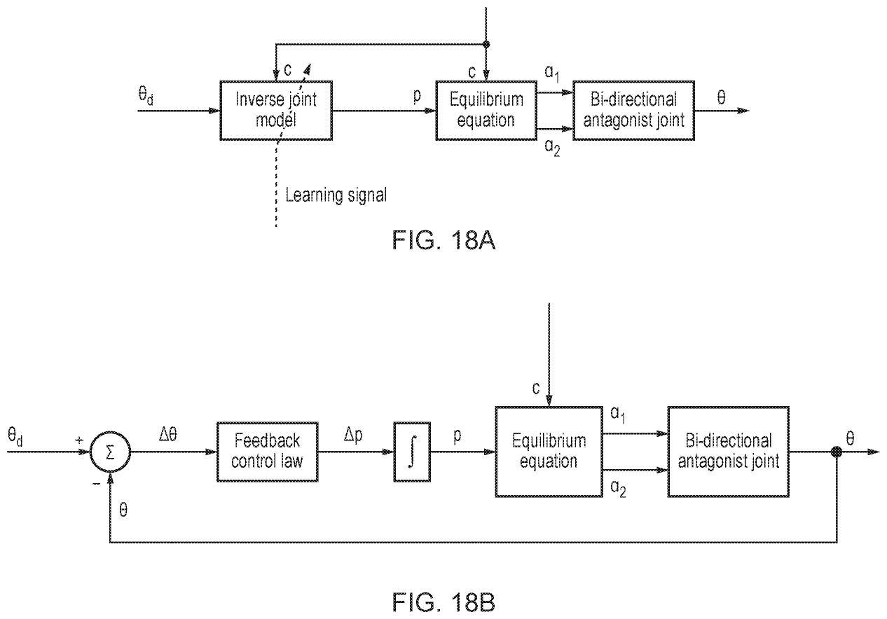

The control architecture for the ballistic phase and closed-loop joint control phase are illustrated in FIGS. 18A and 18B, respectively. In the following the movement of only one joint—the wrist joint 40—is described in order to aid understanding, but the skilled reader will understand that in fact all joints of the arm 100 will move to achieve movement of the end effector 50.

The ballistic phase (FIG. 18A) has as inputs a desired joint angle, θ_{d}, and desired joint stiffness, c. An inverse joint model is used to map the desired joint angle and desired joint stiffness to the corresponding differential position, p, of the driver pulleys 46a, 46b, based on the desired joint angle and desired joint stiffness. Then, an equilibrium equation is used to determine the angular position, α₁, of the driver pulley 46a of the first bi-directional actuator 45a and the angular position, α₂, of the pulley 46b of the second bi-directional actuator 45b that will achieve both the differential position, p, and the desired joint stiffness, c.

The output of the ballistic phase of joint control at t₃ is a joint angle, θ, which is close to θ_{d}, preferably more than 50% of θ_{d}, and ideally 60%, 70%, 80% or 85% or more of θ_{d}. The ballistic phase thus moves the end effector 50 to a nearby location in the vicinity of the initial estimated location of the fruit to be picked, as described further below.

The closed-loop joint control phase (FIG. 18B) also has as inputs the desired joint angle, θ_{d}, and desired joint stiffness, c. The current joint angle, θ, is fed back to the controller to determine a joint angle difference, Δθ, between the current joint angle, θ, and the desired joint angle, θ_{d}, and thereby reduce that difference, Δθ. A feedback control law step determines, based on the joint angle difference, Δθ, a change in differential position, Δp, that will reduce the joint angle difference Δθ. This is then transformed into a differential position, p, which is used by an equilibrium equation to determine the angular position, α₁, of the driver pulley 46a of the first bi-directional actuator 45a and the angular position, α₂, of the pulley 46b of the second bi-directional actuator 45b that will achieve both the differential position, p, and the desired joint stiffness, c.

The output of the closed-loop joint control phase of joint control at t₄ is a joint angle, θ, that is even closer to θ_{d}, preferably exactly at θ_{d}. However, since the joints of the arm 100 are not rigid, but are compliant to a greater or lesser degree, achieving the desired joint angle, θ_{d}, may not result in the end effector being located in precisely in the right position to engage or otherwise manipulate the fruit. Moreover, the target may be moving (e.g. by the action of wind) and/or the location data provided by the joint control phase stereo camera may be inaccurate. The sensor-control phase corrects for these errors at the end of the trajectory, from t₄ to t₆.

Movement through the trajectory of FIG. 17A will now be described, by way of an example of how the arm is controlled in use. As above, in the following the movement of only one joint—the wrist joint 40—is described in order to aid understanding, but the skilled reader will understand that in fact all joints of the arm 100 will move to achieve movement of the end effector 50.

At t₀ the ballistic phase stereo camera is used to generate a three-dimensional point cloud containing target positions of fruit to be picked (or other target positions in other applications). Each target has a position in a Cartesian coordinate system with an origin, or reference point, at or near the base 10 of the arm 100. Once a point of interest has been selected from the point cloud, the ballistic phase trajectory to t₃ is generated and the angular positions, α₁, of the driver pulley 46a of the first bi-directional actuator 45a and the angular position, α₂, of the driver pulley 46b of the second bi-directional actuator 45b at each of t₁, t₂ and t₃ are calculated using the control architecture described above in relation to FIG. 18A.

The joint is then moved from t₁ to t₂ and then to t₃ by controlling the bi-directional actuators 45a, 45b to reach the calculated angular positions and thereby ensure the relative positions of the driver pulleys 46a, 46b at each point of the ballistic phase trajectory is such that the joint has the desired joint pose with the desired level of stiffness.

It can be seen from FIG. 17B that the stiffness of the joint is relatively low during the ballistic phase, though rises from t₃ to t₄ on the approach to the closed-loop joint control phase. During this phase the joint moves relatively fast and the open loop control further speeds up arrival at t₃ by reducing the number of control steps required. This fast movement with limited control has the potential to result in collisions between the arm 100 and an external body, such as a person or structure. However, the relatively low joint stiffness ensures that the arm 100 has a relatively high level of passive compliance during the ballistic phase, with the result that such collisions should not cause damage to either the arm 100 or the external body. The high torque mode may be utilised during the ballistic phase to maximise the torque available to move the joint.

At t₃ the closed loop joint control phase commences. The control architecture described above in relation to FIG. 18B is used to calculate each change in angular position, α₁, of the driver pulley 46a and angular position, α₂, of the pulley 46b required to reduce the joint angle difference, Δθ. The joint is progressively moved towards t₄ by controlling the bi-directional actuators 45a, 45b to reach the calculated angular positions, and repeating until the joint angle difference, Δθ, is zero or within an allowable margin of zero.

It can be seen from FIG. 17B that the stiffness of the joint continues to rise in the closed-loop joint control phase from t₃ to t₄, to a level at which the joint stiffness is relatively high. Passive compliance in this high stiffness mode is thus reduced, but accuracy of joint position increases.

In the sensor-control phase from t₄ to t₆ the high stiffness mode is maintained. During this phase the movement of the joint is controlled based on visual data obtained by the sensor-control phase stereo camera and colour camera. Images obtained by the colour camera are analysed to identify the fruit or vegetable to be picked or otherwise engaged or manipulated using image recognition algorithms. For example, a cluster of pixels in a certain colour range or in a certain pattern may indicate the presence of a fruit or vegetable. The image may also be analysed to determine whether the identified fruit or vegetable is ripe and/or whether it is blemished, and therefore whether or not it should be picked.

Once the fruit or vegetable has been identified images obtained by the approach phase stereo camera are analysed to determine the sensed location of the identified fruit or vegetable in a Cartesian coordinate system that is local to the end effector.

The determined sensed location is compared to the known location of the end effector 50, and the trajectory to be travelled by the end effector 50 is calculated. The angular positions of the driver pulleys 46a, 46b required to achieve the joint positions required to achieve movement along the calculated trajectory are determined, and the joint is moved to move the end effector to the sensed location. The sensed location may change over time as new data from the cameras is obtained. For example, the fruit or vegetable may be moving slightly, or the accuracy of the determined location may improve as the end effector gets closer to the fruit or vegetable. This process may therefore be repeated until the end effector 50 reaches a final location in which it is able to grasp, engage or otherwise manipulate the fruit.

By using sensors (stereo camera and colour camera) that are located in a fixed position relative to the end effector (i.e. able to move in tandem with the end effector) it is possible to calculate the trajectory to be travelled by the end effector in the sensor-control phase within a local coordinate system, which reduces the processing steps required to calculate the necessary joint movements and thereby maximises the speed of motion of the end effector in the sensor-control phase.

Moreover, during the sensor-control phase the position (angle) of the joint(s) may be controlled by open loop control or by closed loop control. Open loop control is preferred, since this will result in fewer control commands, quicker processing, and thus quicker movement of the joint(s).

In the optional detachment phase from t₆ to t₇ the end effector 50 is rapidly moved downwardly to detach the fruit or vegetable, in applications in which the fruit or vegetable can be detached from a stem in this way. Joint movements in this phase are controlled in a similar way to the ballistic phase, via open loop control. It can be seen from FIG. 17B that the joint stiffness is rapidly decreased to a minimum stiffness level in this phase. The rapid decrease in joint stiffness may be caused by a rapid release of highly pre-tensioned tendons in the bi-directional actuators 45a, 45b. This rapid release provides an explosive release of energy at the initial part of the detachment phase, which may help to detach the fruit or vegetable from its stem.

FIG. 19 illustrates an embodiment of a fruit- or vegetable-picking system according to the invention. The system comprises a multi-arm mobile platform 200 which is movable by way of wheels 210 or alternatively by way of a rail or gantry system (not shown). The platform 200 supports four robotic arms 100 according to the first embodiment described above stacked vertically above one another, and each mounted via their base 10 to a vertical support 220 of the platform 200. Each robotic arm 100 delivers picked fruit or vegetables to a dedicated storage container 230, such as a punnet or tray. The platform 200 also supports a cooling storage unit 240 in which the storage containers 230 are placed once full, in order to maximise the shelf life of the fruit or vegetables.

Each robotic arm 100 has an associated ballistic phase stereo camera 250 that provides images including all points accessible by the end effector 50 of that arm 100. Each arm 100 also includes an LED light source (not shown) mounted on the arm so as to have a fixed position relative to the end effector 50, and so as to illuminate an area encompassed by images captured by the colour camera and approach phase stereo camera. This illumination enables fruit or vegetable picking in dark conditions, such as during the night, and also helps to control the light conditions to prevent fluctuations in data quality due to variations in the environmental light quality.

1. A modular robotic arm comprising:
a first joint module comprising:
a first joint that is movable to cause movement between rigid first and second links, the first or second link comprising a first interlocking feature; and
a first variable stiffness actuator having one or more resilient members actuatable to move the first joint; and
a second module comprising a second interlocking feature configured to interlock with the first interlocking feature of the first module,
wherein the robotic arm has an operating mode in which the second interlocking feature is interlocked with the first interlocking feature to thereby operatively connect the second module to the first module, and a reconfiguration mode in which the second interlocking feature is separated from the first interlocking feature to thereby enable the first or second module to be swapped for a replacement module, and
wherein in the operating configuration the one or more resilient members do not engage the second module,
wherein the one or more resilient members are each connected to the first link and the second link, and
wherein the one or more resilient members each comprise an elastic portion that is configured to elongate under an applied tension and be biased to return to its original length upon removal of said applied tension.

2. A robotic arm according to claim 1, wherein the second module comprises either:
an end effector module comprising an end effector arranged to manipulate an object; or
a second joint module comprising a second joint that is movable to cause movement between rigid third and fourth links, the third or fourth link comprising the second interlocking feature, and a second variable stiffness actuator having one or more resilient members actuatable to move the second joint.

3. A robotic arm according to claim 1, wherein the first link comprises the first interlocking feature, the second link comprises a third interlocking feature, and the robotic arm comprises a third module having a fourth interlocking feature arranged to interlock with the third interlocking feature of the first module in the operating mode, the third and fourth interlocking features being separated in the reconfiguration mode to enable the first or third module to be swapped for a replacement module.

4. A robotic arm according to claim 1, wherein one of the first and second interlocking features comprises a female element and the other of the first and second interlocking features comprises a male element arranged to nest within the female element to thereby interlock the first and second interlocking features together.

5. A robotic arm according to claim 1, wherein the first and second interlocking features are interlocked via a sliding connection.

6. A robotic arm according to claim 1, wherein the first and second interlocking features are interlocked via a frictional engagement.

7. A robotic arm according to claim 1, wherein the first and second interlocking features are interlocked via a one-step connection.

8. A robotic arm according to claim 1, wherein the first and second interlocking features are interlocked without additional fastening means.

9. A robotic arm according to claim 1, wherein the first and second interlocking features comprise cooperating sliding dovetail joint features.

10. A robotic arm according to claim 3, wherein one of the third and fourth interlocking features comprises a female element and the other of the third and fourth interlocking features comprises a male element arranged to nest within the female element to thereby interlock the third and fourth interlocking features together.

11. A robotic arm according to claim 1, wherein the one or more resilient members do not extend across the interlocked first and second interlocking features in the operating mode.

12. A robotic arm according to claim 1, wherein the first and/or second variable stiffness actuator comprises a first resilient member of the one or more resilient members actuatable by an increase in tension to urge the joint to move in a first direction, and a second resilient member of the one or more resilient members actuatable by an increase in tension to urge the joint to move in a second direction opposite to the first direction

13. A robotic arm according to claim 1, wherein the first and/or second variable stiffness actuator comprises first and second bi-directional actuators, each bi-directional actuator comprising a first resilient member of the one or more resilient members actuatable by an increase in tension to urge the joint to move in a first direction, and a second resilient member of the one or more resilient members actuatable by an increase in tension to urge the joint to move in a second direction opposite to the first direction.

14. A robotic arm according to claim 1, wherein the first and/or second variable stiffness actuator is operable in a low stiffness mode in which a resultant tension in the one or more resilient members is relatively low and a high stiffness mode in which the resultant tension in the one or more resilient members is relatively high.

15. (canceled)

16. A robotic arm according to claim 1, wherein the first and/or second variable stiffness actuator comprises one or more actuators, each actuator comprising a first pulley rotatable relative to the first link and rotatable in tandem with the second link, a second pulley rotatable relative to the first link, and an actuation link extending between the first and second pulleys, the actuation link including at least one of the one or more resilient members extending between the first and second pulleys whereby rotation of the first or second pulley causes movement of the joint.

17. A kit of parts comprising a robotic arm according to claim 1, and a replacement second module comprising a further second interlocking feature arranged to interlock with the first interlocking feature of the first module, wherein either the second module or replacement second module can be operatively connected to the first module in the operating configuration.

18. A method of operating a robotic arm according to claim 1, comprising the steps of:
disconnecting the first and second interlocking features;
replacing the first or second module with a replacement module comprising a further interlocking feature; and
interlocking the first or second interlocking feature with the further interlocking feature to arrange the robotic arm in the operating mode.

19. A system for harvesting fruit or vegetables comprising a movable base supporting one or more robotic arms according to claim 1.

20-46. (canceled)
